(19) United States
(12) Patent Application Publication
(10) Pub. No.: US 2021/0280028 A1
(43) Pub. Date: Sep. 9, 2021

(54) Roof-Mounted Automobile Surveillance Apparatus

(71) Applicants: Samuel Levy, Sherman Oaks, CA (US); Ardelle Levy, Sherman Oaks, CA (US)

(72) Inventors: Samuel Levy, Sherman Oaks, CA (US); Ardelle Levy, Sherman Oaks, CA (US)

(21) Appl. No.: 16/808,461

(22) Filed: Mar. 4, 2020

(51) Int. Cl. G08B 13/196; B60R 11/04; G06K 9/00

(52) U.S. Cl. CPC G08B 13/19619; G08B 13/19632; B60R 11/04; B60R 2011/004; G06K 9/00771; G06K 9/00295; B60R 2300/102; G06K 9/00791

(57) ABSTRACT

A roof-mounted automobile surveillance apparatus for creating a surveillance network on streets to improve public safety includes a base to attach to a roof of a vehicle. A dome cover is coupled to the base outer edge and extends above the base top side. The dome cover is transparent and weatherproof. A camera housing is coupled to the base. The camera housing is coupled to the base top side within the dome cover. A camera is coupled within the camera housing. The camera has a plurality of lenses extending through the camera housing. A CPU, a battery, a memory card slot, a GPS transceiver, and a cellular transceiver are coupled to the base within the base inside.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to surveillance devices and more particularly pertains to a new surveillance device for creating a surveillance network on streets to improve public safety.

### (2) Description of Related Art including information disclosed under 37 CFR 1.97 and 1.98

The prior art relates to surveillance devices mounted on vehicles. Most existing devices are for theft prevention or accident recording and thus do not integrate with a network to share gathered footage and do not have the ability to read license plates or perform facial recognition. Existing devices also often do not achieve a 360° field of vision.

### (h) BRIEF SUMMARY OF THE INVENTION

An embodiment of the disclosure meets the needs presented above by generally comprising a base having a base top side, a base bottom side, and a base outer edge defining a base inside. The base is configured to attach to a roof of a vehicle. A dome cover is coupled to the base outer edge and extends above the base top side. The dome cover is transparent and weatherproof. A camera housing is coupled to the base. The camera housing is coupled to the base top side within the dome cover. A camera is coupled within the camera housing. The camera has a plurality of lenses extending through the camera housing. A CPU is coupled to the base within the base inside and is in operational communication with the camera. A battery, a memory card slot, a GPS transceiver, and a cellular transceiver are coupled to the base within the base inside and are in operational communication with the camera and the CPU.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a roof-mounted automobile surveillance apparatus according to an embodiment of the disclosure.

FIG. 2 is a front elevation view of an embodiment of the disclosure.

FIG. 3 is a bottom plan view of an embodiment of the disclosure.

FIG. 4 is an in-use view of an embodiment of the disclosure.

FIG. 5 is an in-use view of an embodiment of the disclosure.

FIG. 6 is a block diagram of an embodiment of the disclosure.

### (j) DETAILED DESCRIPTION OF THE INVENTION

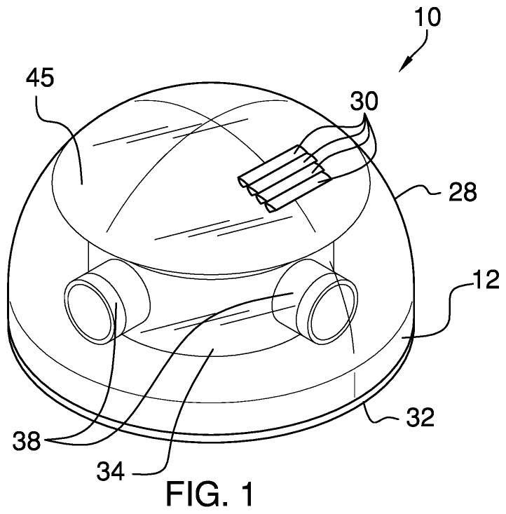

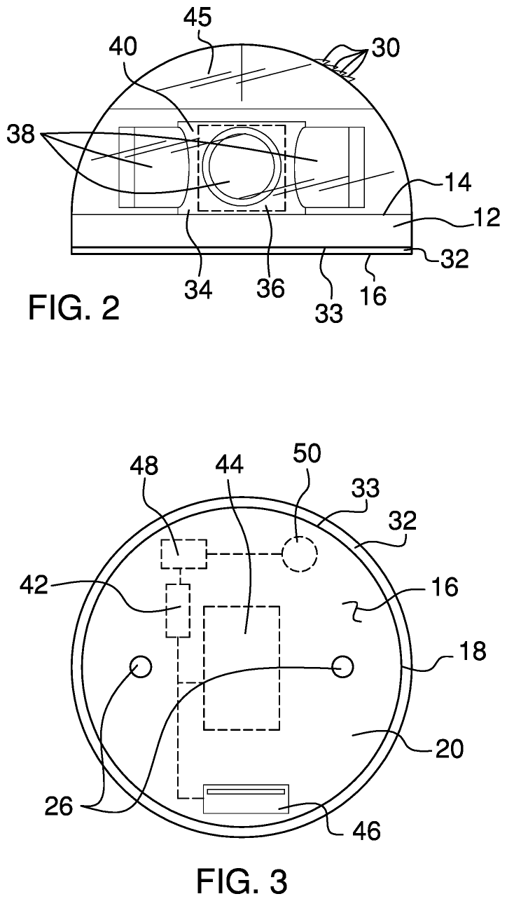

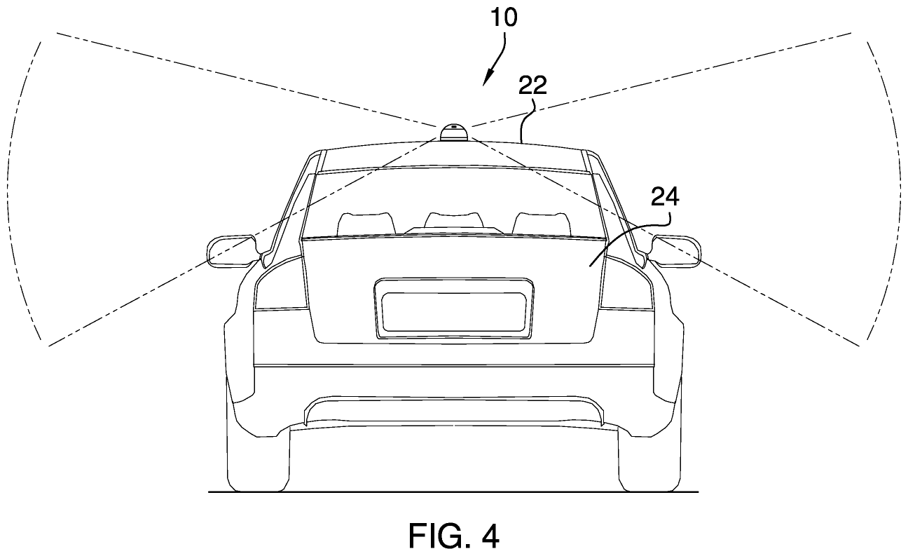

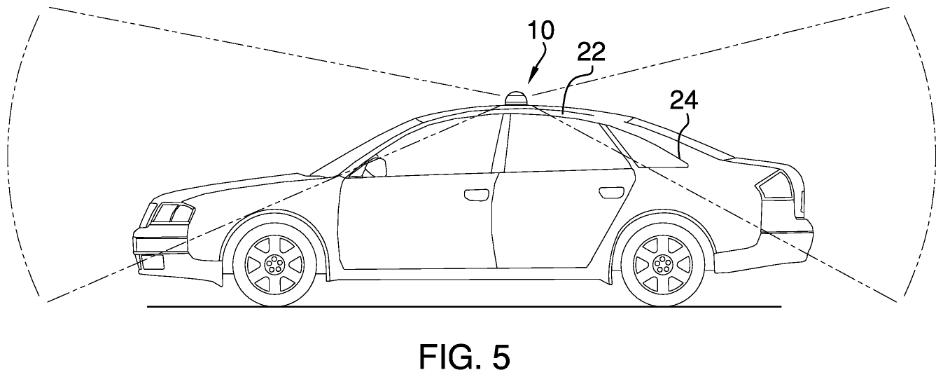

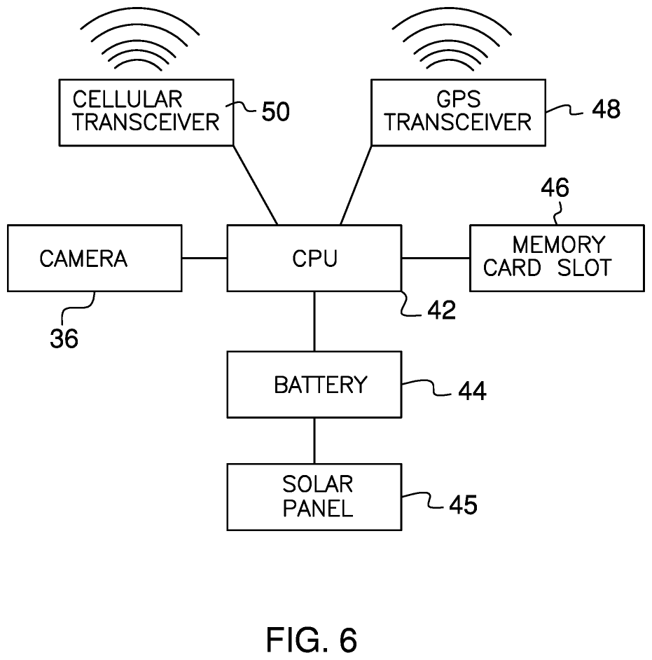

With reference now to the drawings, and in particular to FIGS. 1 through 6 thereof, a new surveillance device embodying the principles and concepts of an embodiment of the disclosure and generally designated by the reference numeral 10 will be described.

As best illustrated in FIGS. 1 through 6, the roof-mounted automobile surveillance apparatus 10 generally comprises a base 12 having a base top side 14, a base bottom side 16, and a base outer edge 18 defining a base inside 20. The base 12 is configured to attach to a roof 22 of a vehicle 24. The base 12 may have a pair of mounting apertures 26 extending from the base top side 14 through the base bottom side 16 to receive mounting hardware. The base 12 may be disc-shaped.

A dome cover 28 is coupled to the base 12. The dome cover 28 is coupled to the base outer edge 18 and extends above the base top side 14. The dome cover 28 may be hemispherical for optimal volume and aerodynamics. There may be a plurality of louvered ventilation slots 30 extending through the dome cover 28 to prevent the apparatus 10 from overheating. A weatherproof seal 32 may be coupled to a bottom edge 33 of the dome cover to further prevent water from entering the dome cover 28. The dome cover 28 is transparent and weatherproof.

A camera housing 34 is coupled to the base top side 14 within the dome cover 28. The camera housing 34 may be cylindrical. A camera 36 is coupled within the camera housing 34 and has a plurality of lenses 38 perpendicularly extending through a housing sidewall 40 of the camera housing. The plurality of lenses 38 may be four lenses 38 each spaced 90° apart around the housing sidewall 40. The plurality of lenses 38 achieve a 360° field of vision for the camera 36 around the vehicle 24. A CPU 42 is coupled to the base 12 within the base inside 20 and is operational communication with the camera 36. The camera 36 and the CPU 42 may perform facial recognition and license plate reading.

A battery 44 is coupled to the base 12 within the base inside 20. The battery 44 is in operational communication with the camera 36 and the CPU 42. The battery 44 may be configured to connect to the electrical system of the vehicle 24. A solar panel 45 may be coupled to the dome cover 28 above the camera housing 34. The solar panel 45 may conform to the curvature of the dome cover 28 to maximize surface area. The solar panel 45 is in operational communication with the battery 44.

A memory card slot 46 is coupled to the base 12 within the base inside 20. The memory card slot 46 is in operational communication with the CPU 42 and is configured to store video captured by the camera 36 to a memory card or hard drive engaged within the memory card slot 46.

A GPS transceiver 48 and a cellular transceiver 50 are coupled to the base 12 within the base inside 20. The GPS transceiver 48 and the cellular transceiver 50 are in operational communication with the CPU 42 to share video captured by the camera 36 and information gathered with recognized faces and license plates to a server.

In use, the base 12 is attached to the roof 22 of the vehicle 24. The apparatus 10 then is in a mode of constant surveillance and communication with the server via the cellular transceiver 50 and can be notified of a particular missing person, person of interest, or license plate of a wanted vehicle. The CPU 42 then processes the video stream from the camera 36 and can alert law enforcement of the location via the GPS transceiver 48 when detected.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A roof-mounted automobile surveillance apparatus comprising:
a base having a base top side, a base bottom side, and a base outer edge defining a base inside, the base being configured to attach to a roof of a vehicle;
a dome cover coupled to the base, the dome cover being coupled to the base outer edge and extending above the base top side, the dome cover being transparent and weatherproof;
a camera housing coupled to the base, the camera housing being coupled to the base top side within the dome cover;
a camera coupled within the camera housing, the camera having a plurality of lenses extending through the camera housing;
a CPU coupled to the base within the base inside, the CPU being in operational communication with the camera;
a battery coupled to the base within the base inside, the battery being in operational communication with the camera and the CPU;
a memory card slot coupled to the base within the base inside, the memory card slot being in operational communication with the CPU;
a GPS transceiver coupled to the base within the base inside, the GPS transceiver being in operational communication with the CPU; and
a cellular transceiver coupled to the base within the base inside, the cellular transceiver being in operational communication with the CPU.

2. The roof-mounted automobile surveillance apparatus of claim 1 further comprising a solar panel coupled to the dome cover above the camera housing, the solar panel being in operational communication with the battery.

3. The roof-mounted automobile surveillance apparatus of claim 1 further comprising a plurality of louvered ventilation slots extending through the dome cover.

4. The roof-mounted automobile surveillance apparatus of claim 1 further comprising a weatherproof seal coupled to a bottom edge of the dome cover.

5. The roof-mounted automobile surveillance apparatus of claim 1 further comprising the camera housing being cylindrical.

6. The roof-mounted automobile surveillance apparatus of claim 5 further comprising the plurality of lenses of the camera perpendicularly extending through a housing sidewall of the camera housing.

7. The roof-mounted automobile surveillance apparatus of claim 6 further comprising the plurality of lenses being four lenses each spaced 90° apart around the housing sidewall.

8. The roof-mounted automobile surveillance apparatus of claim 1 further comprising the camera and the CPU performing facial recognition and license plate reading.

9. A roof-mounted automobile surveillance apparatus comprising:
a base having a base top side, a base bottom side, and a base outer edge defining a base inside, the base being configured to attach to a roof of a vehicle;
a dome cover coupled to the base, the dome cover being coupled to the base outer edge and extending above the base top side, a plurality of louvered ventilation slots extending through the dome cover, a weatherproof seal being coupled to a bottom edge of the dome cover, the dome cover being transparent and weatherproof;
a camera housing coupled to the base, the camera housing being coupled to the base top side within the dome cover, the camera housing being cylindrical;
a camera coupled within the camera housing, the camera having a plurality of lenses perpendicularly extending through a housing sidewall of the camera housing, the plurality of lenses being four lenses each spaced 90° apart around the housing sidewall;
a CPU coupled to the base within the base inside, the CPU being in operational communication with the camera, the camera and the CPU performing facial recognition and license plate reading;
a battery coupled to the base within the base inside, the battery being in operational communication with the camera and the CPU;
a solar panel coupled to the dome cover above the camera housing, the solar panel being in operational communication with the battery;
a memory card slot coupled to the base within the base inside, the memory card slot being in operational communication with the CPU;
a GPS transceiver coupled to the base within the base inside, the GPS transceiver being in operational communication with the CPU; and
a cellular transceiver coupled to the base within the base inside, the cellular transceiver being in operational communication with the CPU.
